(19) United States
(12) Patent Application Publication
(10) Pub. No.: US 2022/0180715 A1
(43) Pub. Date: Jun. 9, 2022

(54) METHOD OF OPERATING A MACHINE FOR A PRODUCTION FACILITY

(71) Applicant: UNITED GRINDING GROUP AG, Bern (CH)

(72) Inventors: Christoph PLUESS, Burgdorf (CH); Urs DIERGARDT, Bern (CH); Christian JOSI, Steffisburg (CH); Marcus KOEHNLEIN, Rumlang (CH)

(73) Assignee: UNITED GRINDING GROUP AG, Bern (CH)

(21) Appl. No.: 17/541,631

(22) Filed: Dec. 3, 2021

(30) Foreign Application Priority Data
Dec. 4, 2020 (EP) 20211977.2

(51) Int. Cl. G08B 3/10; G08B 21/18

(52) U.S. Cl. CPC G08B 3/10; G08B 21/18

(57) ABSTRACT

A method of operating a machine for a production facility, in particular a machine tool. According to the method, at least one machine condition signal; characterizing an operating condition of the machine is obtained and at least one audio signal representing the at least one machine condition signal is generated. The at least one audio signal is presented to an operator operating the machine. Further, at least one relative position in space is assigned to the at least one audio signal and the at least one audio signal is presented to the operator such that it is deemed to emerge from the relative position in space assigned to the audio signal.

### CROSS-REFERENCE TO RELATED APPLICATION

The present application hereby claims priority under 35 U.S.C. § 119 to European patent application No. EP 20 211 977.2, filed on Dec. 4, 2020, the entire contents of which are hereby incorporated herein by reference.

### BACKGROUND

### Technical Field

Example embodiments of the present disclosure relates to a method of operating a machine for a production facility, in particular a machine tool, and/or a machine for a production facility, in particular a machine tool.

### Related Art

Operating a machine for a production facility may require actions performed by an operator. The amount of such actions depends, inter alia, on the degree of automation of the machine. Especially in the case of highly automated machines, operators may perform many different tasks, such as maintenance of the machine or service work. In order to perform such tasks, the operators are provided with information characterizing an operating condition of the machine.

Conventionally, an actual state of a machine tool may be determined by having a measuring device arranged on the machine tool that comprises a structure-borne sound sensor. The measuring device determines an actual state of the machine tool on the basis of structure-borne sound signals. Further, the machine tool comprises an output unit to output a derived value such that in-process monitoring by an operator is possible.

Further, the related art discloses a mechanical grinder station anomaly detector that acquires audio signals of machine running noise in real time, converts the audio signals into a digital signal, performs spectrum analysis and extracts an amplitude map and a frequency map. The mechanical grinder station anomaly detector further comprises a user interface to output the amplitude map, frequency map, and the audio signal.

However, it is still difficult for an operator to keep track of all the outputs regarding the actual state of a machine and to locate the parts of the machine that may need the attention of the operator.

### SUMMARY

At least some example embodiments are directed to a method of operating a machine for a production facility that improves the presentation of a machine condition to an operator, in particular to simplify keeping track of outputs regarding the machine condition and locating parts of the machine that may need the attention of the operator. At least some other example embodiments are directed to a machine for a production facility that improves the presentation of a machine condition to an operator.

In an example embodiment of the present disclosure, a method of operating a machine for a production facility is provided. Here, “operating” refers both to the regular operation of the machine, i.e., when the machine produces an item, and to maintenance and/or service work. Said maintenance and/or service work may be performed while the machine is running or when the machine is stopped.

The machine for the production facility may in principle be any kind of machine and is particularly a production machine, i.e., a machine that produces an item. Here, production may refer to any manufacturing process, in particular to manufacturing processes comprising forming, cutting and/or joining. Very particularly, the machine is a machine tool, e.g., a grinding tool. Also, the method may relate to the complete machine or just to parts of the machine.

The method comprises a step of obtaining at least one machine condition signal characterizing an operating condition of the machine. Said operating condition may be a normal or an abnormal operating condition of the machine.

The method further comprises a step of generating at least one audio signal representing the at least one machine condition signal. Said at least one audio signal is presented to an operator operating the machine. Audio signals do not require the operator to look at a display, therefore they directly catch the operator's attention, simplify keeping track of the operating condition of the machine and allow the operator to look at the machine while listening to the audio signal.

The method further comprises a step of assigning at least one relative position in space to the at least one audio signal. Here, the relative position in space may be a three-dimensional position and may be relative to the machine or to the operator.

The method further comprises a step of presenting the at least one audio signal to the operator such that it is deemed to emerge from the relative position in space assigned to the audio signal, i.e., a 3D audio effect is created. Hence, locating parts of the machine that may need the attention of the operator is simplified. The presentation of the audio signal to the operator such that it is deemed to emerge from said relative position in space may be performed using a stereo signal that is emitted from headphones or at least two speakers.

In an example, the operator operates the machine in dependence on the audio signals presented to the operator. In particular, if the audio signals point to an abnormal behavior of the machine, the operator investigates the abnormal behavior of the machine and/or stops the machine in order to prevent damage to the machine due to the abnormal behavior.

In an example, at least one of the machine condition signals is a time-sequential signal, e.g., a vibration, a rotation or an oscillation. Said time-sequential signal may be a sound stemming, for example, from a grinding tool, from a drive shaft or from an actuator. Said time-sequential signal may also be an electric signal, stemming, e.g., from a fluctuation in currents. Further, the time-sequential signal may stem from fluctuations of sheet plates.

In an example, the audio signal is generated from the time-sequential signal by a transformation of the time-sequential signal, e.g., by a shift and/or by scaling the frequencies of the time-sequential signal, in particular into the audible spectrum. That way, the operator can directly listen to the machine condition signal and therefore determine whether the machine is operating normally or abnormally. An experienced operator can even determine a likely cause for an abnormal machine behavior by listening to the transformed time-sequential signal.

In an example, the time-sequential signal is analyzed and characteristics of the time-sequential signal that identify behavior of the machine are transformed such that the operator can more easily recognize them. Such transformation may, e.g., be an amplification of the characteristics of the time-sequential signal that identify behavior of the machine. By amplifying said characteristics, they are more prominent to the operator and therefore the operator's attention is drawn to them. Also, by amplifying the characteristics that identify behavior of the machine, it is easier to distinguish abnormal behavior from normal behavior of the machine. The analysis to identify the characteristics that identify behavior of the machine may, for example, include a subtraction of a known time-sequential signal for normal behavior of the machine from the time-sequential signal.

In an example, at least one of the machine condition signals is analyzed and characteristic machine condition events, in particular machine condition sound events, are separated from one another. The separation may, for example, be based on sound signals obtained from different microphones. Once the characteristic machine condition events are separated from one another, it is easier for the operator to focus on one of the machine condition events at a time.

In an example, at least one of the machine condition signals is analyzed and the audio signal representing said machine condition signal is chosen from a sound database, based on the result of the analysis of said machine condition signal. An audio signal chosen from a sound database is particularly useful when the machine condition signal is not an audible signal and cannot be transformed into an audible signal. In that case, the audio signal chosen from the sound database may inform the operator about normal or abnormal behavior of the machine. The sound database may be allocated to the machine, may be a central database for the production facility or may be in a decentral system, e.g. in a cloud.

In an example, the sound database contains a plurality of event sounds, wherein each event sound is mapped to a machine operating condition, e.g., a notification, an alert, a warning or an alarm. Hence, when the operator hears a certain event sound, he will know what machine operating condition it corresponds to and will operate the machine accordingly. The operator may also train the mapping of event sounds to machine operating conditions by providing feedback to the respective event sounds.

In an example, the relative position in space assigned to the audio signal corresponds to the position in space where the machine condition signal that is represented by the audio signal originates. Hence, the operator can locate an abnormally operating machine part by listening to the audio signals. This has the further advantage that the operator can observe the machine when looking for a fault instead of having to look at a display.

In an example, a position and/or orientation of the operator is determined and the relative positions in space assigned to the audio signals are chosen relative to said position and/or orientation of the operator. That way, the operator receives personalized audio signals that allow him to easily locate the position of a fault or of a machine part that operates abnormally. The position of the operator may be determined by a camera, by a proximity sensor or by a unit worn by or attached to the operator, such as a wireless communication unit or a radio frequency identification unit. The orientation of the operator may be determined by a camera, by dynamic head tracing, e.g., with headphones, or by determining the viewing direction of the operator, e.g., with smart glasses.

In an example, one or more of the audio signals are highlighted by placing their relative positions in space closer to the operator. On one hand, such placement of the relative positions of the audio signals will amplify said audio signals, which alerts the operator. On the other hand, more attention is paid to an audio signal being close by compared to an audio signal being far away.

In an example, the at least one audio signal is presented to the operator when the operator is located in the vicinity of the machine. That way, only a selection of audio signals is presented to the operator, making it easier to identify specific audio signals. Also, the operator is already in the vicinity of the machine when he receives the audio signal and can therefore directly operate said machine, e.g. by servicing it. Alternatively, the at least one audio signal is presented to the operator when the operator is located at a distance from the machine or when the operator is located at a remote location. That way, the operator can listen to audio signals representing the machine condition without having to be close to the machine. This is particularly useful when it is unsafe to be located close to the machine or when one highly trained operator is asked to find a fault in a remotely located machine.

In another aspect of the present disclosure, a machine for a production facility is provided. Said machine may in principle be any kind of machine and is particularly a production machine, i.e., a machine that produces an item. Here, production may refer to any manufacturing process, in particular to manufacturing processes comprising forming, cutting and/or joining. Very particularly, the machine is a machine tool, e.g., a grinding tool.

The machine comprises at least one machine condition detection unit for obtaining a machine condition signal characterizing an operating condition of the machine. Said operating condition may be a normal or an abnormal operating condition of the machine.

The machine further comprises at least one audio signal generation unit for generating an audio signal representing the machine condition signal and at least one audio transmission unit for transmitting the audio signal to an operator operating the machine. The audio signal generation unit may be a central unit. Alternatively, there may be one audio signal generation unit per machine or the audio signals may be generated in a decentral system, e.g., a cloud. The audio transmission unit may comprise, for example, headphones or at least two speakers. Audio signals do not require the operator to look at a display, therefore they directly catch the operator's attention, simplify keeping track of the operating condition of the machine and allow the operator to look at the machine while listening to the audio signal.

The machine is adapted to be operated according to the method described above and features the advantages described above.

It shall be understood that example embodiments of the disclosure can also be any combination of the above-mentioned features.

These and other aspects of the disclosure will be apparent from and elucidated with reference to the example embodiments described hereinafter.

### BRIEF DESCRIPTION OF THE DRAWINGS

In the following, example embodiments of the disclosure will be described, by way of example only, and with reference to the drawings in which:

FIG. 1 shows a schematic top view of a production facility;

FIG. 2 shows a flowchart of a method of operating a machine for a production facility; and

FIG. 3 shows an audio signal generation unit according to example embodiments.

### DETAILED DESCRIPTION

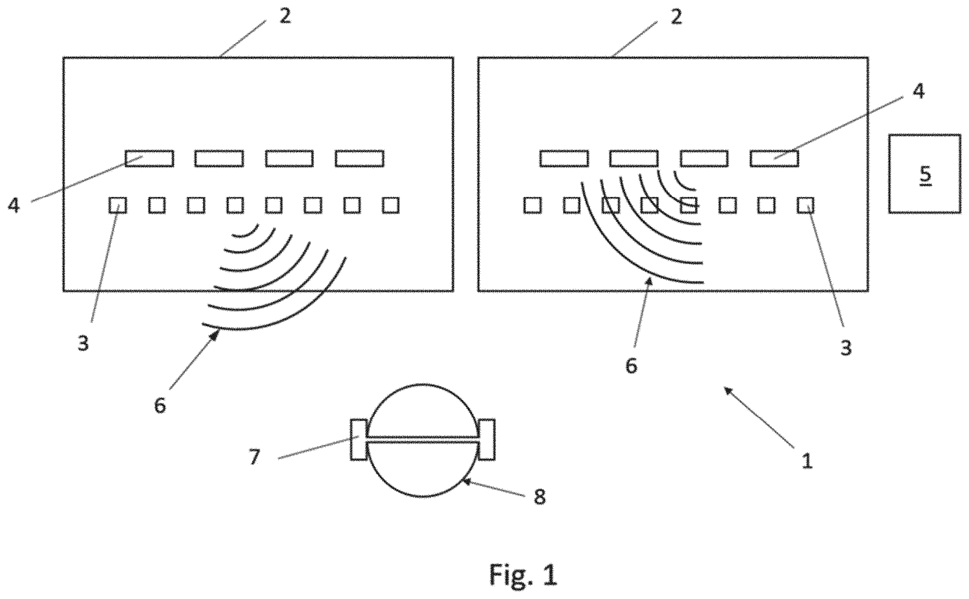

FIG. 1 shows a schematic top view of a production facility 1 comprising two machines 2. The machines 2 may be machine tools, e.g., grinding tools, but may also be any other kind of machine, particularly production machines, i.e., machines that produce item. Here, production may refer to any manufacturing process, in particular to manufacturing processes comprising forming, cutting and/or joining.

The machines 2 each comprise a plurality of microphones 3 and other sensors 4 such as electric sensors, mechanical sensors, temperature sensors or machine specific sensors. The microphones 3 and other sensors 4 obtain machine condition signals that characterize an operating condition of the machine 2.

The production facility 1 further comprises an audio signal generation unit 5 which receives the machine condition signals from the microphones 3 and other sensors 4. In the example shown in FIG. 1, the machine condition signal of one of the microphones 3 points to an out-of-the-norm-behavior of the machine 2. Therefore, the audio signal generation unit 5 generates an audio signal 6 representing said machine condition signal. Also, the machine condition signal of one of the other sensors 4 points to an out-of-the-norm-behavior of the machine 2. Therefore, the audio signal generation unit 5 also generates an audio signal 6 representing the machine condition signal of the other sensor 4.

The audio signals 6 are generated such that they deem to emerge from the position in space where the machine condition signal that is represented by the audio signal 6 originates, i.e., a 3D audio effect is created.

The production facility 1 further comprises an audio transmission unit 7, which is depicted in FIG. 1 as headphones worn by an operator 8.

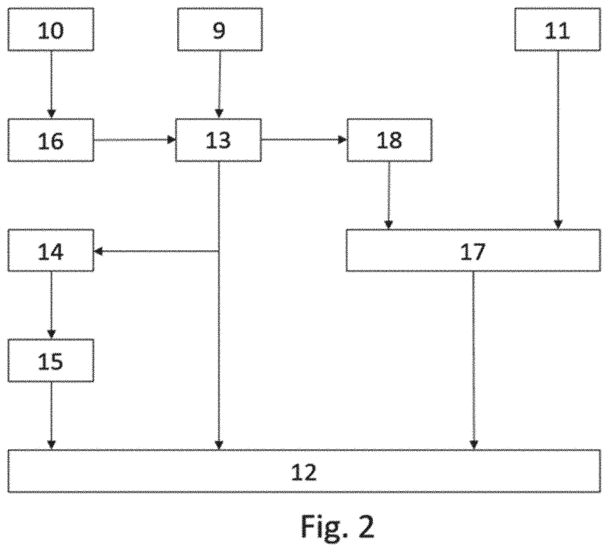

FIG. 2 shows a flowchart illustrating a method of operating the machine 2 for the production facility 1.

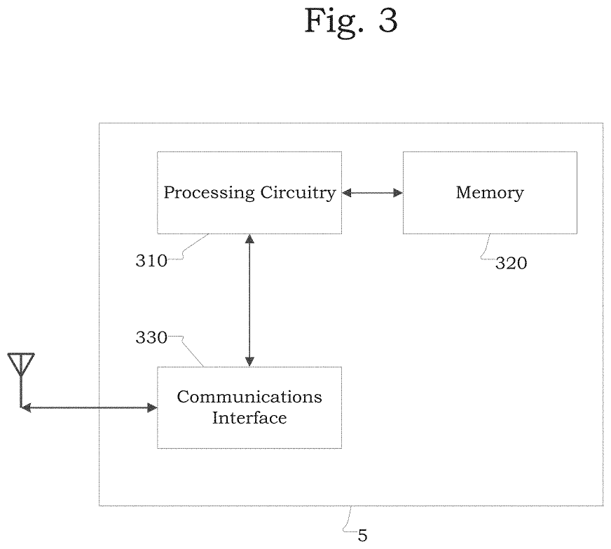

FIG. 3 shows an audio signal generation unit 5 according to example embodiments.

Referring to FIGS. 1 to 3, the audio signal generation unit 5 may include processing circuitry 310, a memory 320 and a communication interface 330.

For example, the processing circuitry may include hardware including logic circuits; a hardware/software combination such as a processor executing software; or a combination thereof and memory. For example, the processing circuitry more specifically may include, but is not limited to, a central processing unit (CPU), an arithmetic logic unit (ALU), a digital signal processor, a microcomputer, a field programmable gate array (FPGA), a programmable logic unit, a microprocessor, application-specific integrated circuit (ASIC), etc. In some example embodiments, the audio signal generation unit may include a signal processor. The processing circuitry may execute software including a plurality of instructions that transform the processing circuitry into special purpose processing circuitry to process machine condition signals collected from the microphones 3 and other sensors 4 of the machines 2, and generate the audio signal 6 representing the machine condition signals. The special purpose processing circuitry may improve the functioning of the production facility 1 itself by generating the audio signals to be presented to the operator 8 that convey relevant information regarding the condition of the machines 2 to the operator 8 audibly so that the operator 8 does not have to look at a display in order to obtain information about the machine condition.

In operations 9-11, several different types of machine condition signals characterizing an operating condition of the machine 2 are obtained. For example, sound signals may be obtained in operation 9, time-sequential signals may be obtained in operation 10 and other events may be recorded in operation 11. For example, the sound signals 9 may be picked up by the microphone 3.

In operation 13, the sound signals 9 may be processed by the audio signal generation unit 5 before being presented to the operator 8. Such processing 13 may include amplifying, diminishing, shifting the frequencies or scaling the frequencies.

Alternatively, the processing 13 of the sound signals 9 may include having the sound signals 9 undergo a spatial sound analysis 14 which separates characteristic sound events from each other. Thereafter, in operation 15, a subsequent spatial sound synthesis may be performed by assigning locations in space to the characteristic sound events

In operation 12, the resulting sound may be presented to the operator 8.

The time-sequential signals generated in operation 10 are signals that vary over time but are not sound signals 9. In operation 16, such time-sequential signals 10 are transformed into sound signals. Thereafter, the transformed signals are and then further processed in operation 13 as if they were sound signals 9.

The other events generated in operation 11 may include, for example, temperature signals, warnings and/or alerts. These are signals that cannot be transformed into sound signals. However, in order to present 12 said other events 11 to the operator 8, in operation 17, the other events 11 are mapped to event sounds stored in a database by the audio signal generation unit 5. For example, a warning is mapped to one sound, an alert is mapped to a different sound and a too high temperature reading is mapped to yet a different sound.

Further, in addition to mapping the other events 11, the processed 13 sound signals 9 and the time-sequential signals 10 that have been transformed and processed in operations 16 and 13, respectively, may be further analyzed and classified as events by the audio signal generation unit 5 in operation 18. For example, a worn-down grinding tool produces a characteristic sound that can be recognized by a computer and be classified 18 as an event. Thereafter, such classified events may then also be mapped in operation 17 by the audio signal generation unit 5 to an event sound stored in the database just like the other events 11.

Since, in operation 12, the operator 8 is presented with the audio signals 6, the operator 8 does not have to look at a display in order to obtain information about the machine condition. Further, the audio signals 6 directly catch the operator's 8 attention, thus, simplifying keeping track of the operating condition of the machine 2 and allowing the operator 8 to look at the machine 2 while listening to the audio signals 6.

While example embodiments of the present disclosure have been illustrated and described in detail in the drawings and foregoing description, such illustration and description are to be considered illustrative or exemplary and not restrictive; the disclosure is not limited to the disclosed embodiments.

Other variations to the disclosed example embodiments can be understood and effected by those skilled in the art in practicing the claimed disclosure, from a study of the drawings, the disclosure, and the appended claims. In the claims, the word “comprising” does not exclude other elements or steps, and the indefinite article “a” or “an” does not exclude a plurality. Any reference signs in the claims should not be construed as limiting the scope.

### LIST OF REFERENCE SIGNS

1 production facility
2 machine
3 microphone
4 other sensor
5 audio signal generation unit
6 audio signal
7 audio transmission unit
8 operator
9 sound signal
10 time-sequential signal
11 other event
12 presenting
13 processing
14 spatial sound analysis
15 spatial sound synthesis
16 transforming
17 mapping
18 classifying

1. A method of operating a machine within a production facility, the method comprising:
obtaining at least one machine condition signal characterizing an operating condition of the machine;
generating at least one audio signal representing the at least one machine condition signal such that at least one relative position in space is assigned to the at least one audio signal; and
presenting the at least one audio signal to an operator operating the machine such that the at least one audio signal is deemed to emerge from the relative position in space assigned to the at least one audio signal.

2. The method according to claim 1, wherein the operator operates the machine in dependence on the at least one audio signal presented to the operator.

3. The method according to claim 1, wherein the at least one of the machine condition signal is a time-sequential signal, the time-sequential signal being a vibration, a rotation or an oscillation.

4. The method according to claim 3, wherein the generating the audio signal comprises:
generating the audio signal from the time-sequential signal by transforming the time-sequential signal, the transforming including a shift or scaling of frequencies of the time-sequential signal into an audible spectrum.

5. The method according to claim 3, wherein the transforming further comprises:
analyzing the time-sequential signal to identify characteristics of the time-sequential signal and amplify the characteristics such that that the operator can more easily recognize the characteristics.

6. The method according to claim 1, wherein the generating comprises:
analyzing the at least one of the machine condition signal to identify and separate particular machine condition sound events therein.

7. The method according to claim 1, wherein the generating comprises:
analyzing the at least one machine condition signal; and
selecting the audio signal representing the at least one machine condition signal from a sound database based on a result of analyzing the at least one machine condition signal.

8. The method according to claim 7, wherein the sound database contains a plurality of event sounds, and wherein the method further comprises:
mapping each of the plurality of event sounds to a machine operating condition, the machine operating condition including a notification, an alert, a warning or an alarm.

9. The method according to claim 1, wherein the relative position in space assigned to the audio signal corresponds to the at least one relative position in space where the machine condition signal that is represented by the audio signal originates.

10. The method according to a claim 1, further comprising:
determining one or more of a position or orientation of the operator; and
assigning the relative position in space to the at least one audio signal relative to the one or more of the position or orientation of the operator.

11. The method according to claim 1, further comprising:
highlighting one or more of the at least one audio signal by placing a relative position thereof in space closer to the operator.

12. The method according to claim 1, wherein the at least one audio signal is presented to the operator when the operator is located in a vicinity of the machine.

13. A machine for a production facility, comprising:
at least one machine condition detection device configured to obtain a machine condition signal characterizing an operating condition of the machine;
at least one audio signal generation device configured to generate at least one audio signal representing the machine condition signal such that at least one relative position in space is assigned to the at least one audio signal; and
at least one audio transmission device configured to transmit the at least one audio signal to an operator operating the machine such that the at least one audio signal is deemed to emerge from the relative position in space assigned to the audio signal.

14. The machine according to claim 13, wherein the at least one audio signal generation device includes processing circuitry configured to,
analyze the at least one machine condition signal; and
select the audio signal representing the at least one machine condition signal from a sound database based on a result of analyzing the at least one machine condition signal.

15. The machine according to claim 14, wherein the processing circuitry is configured to select the audio signal from the sound database such that the audio signal presented to the operator varies based on the operating condition of the machine.
